(19) United States
(12) Patent Application Publication
(10) Pub. No.: US 2025/0083251 A1
(43) Pub. Date: Mar. 13, 2025

(54) LASER MACHINING DEVICE

(71) Applicant: Panasonic Intellectual Property Management Co., Ltd., Osaka (JP)

(72) Inventors: KOJI FUNAMI, Kyoto (JP); KAZUKI FUJIWARA, Osaka (JP); IZURU NAKAI, Osaka (JP); TATSURO SHIRAISHI, Osaka (JP)

(21) Appl. No.: 18/961,344

(22) Filed: Nov. 26, 2024

Related U.S. Application Data
(63) Continuation of application No. PCT/JP2023/006335, filed on Feb. 22, 2023.

(30) Foreign Application Priority Data
May 31, 2022 (JP) 2022-088961

(51) Int. Cl. B23K 26/064; B23K 26/36

(52) U.S. Cl. CPC B23K 26/064; B23K 26/36

(57) ABSTRACT

A laser machining device according to one aspect of the present disclosure includes: a welding device that irradiates a workpiece with laser irradiation light to perform welding; and a welding light measurement device including an imaging optical system, a first photodetector, and a second photodetector, the welding light measurement device receiving and measuring welding light emitted from the workpiece during laser welding. The welding light includes first light in a first wavelength region and second light in a second wavelength region, and the imaging optical system includes a wavelength selection mask, and forms an image of a light beam of the first light transmitted through the wavelength selection mask on the first photodetector and forms an image of a light beam of the second light transmitted through the wavelength selection mask on the second photodetector. The wavelength selection mask includes a first region and a second region that receive the welding light, the first region reflects the second light and transmits the first light, the second region transmits the first light and the second light, and the second region has a smaller light receiving area than the first region. The first photodetector and the second photodetector are disposed on an optical axis of the welding light incident on the wavelength selection mask.

### TECHNICAL FIELD

The present disclosure relates to a laser machining device, and more particularly to a laser machining device capable of measuring welding light emitted from a workpiece to evaluate welding quality when laser welding is performed by irradiating the workpiece with laser irradiation light.

### BACKGROUND ART

Some laser machining devices perform laser welding by irradiating a workpiece with pulsed or continuous laser irradiation light. In addition, the quality of laser welding can be evaluated by measuring welding light emitted from a welded portion when laser welding is performed. In a quality evaluation method of the laser welding, for example, the quality evaluation of the laser welding can be performed in real time based on the peak intensity or the average intensity of the welding light emitted during the laser welding. Here, the welding light includes reflected light of the laser light incident on the laser irradiation light from the welded portion of the workpiece and plasma light generated in the process of welding during laser welding.

For quality evaluation of laser welding, for example, there is a welding state detection device proposed in PTL 1. PTL 1 discloses the welding state detection device that transmits welding light emitted from a welded portion during laser welding by an optical fiber, performs wavelength separation by a dichroic mirror (wavelength separation mirror), measures obtained plasma light and laser reflected light using two independent measurement optical systems, and evaluates welding quality.

### CITATION LIST

### Patent Literature

PTL 1: Unexamined Japanese Patent Publication No. 2000-334587

### SUMMARY OF THE INVENTION

However, in the welding state detection device of PTL 1, the welding light is measured by spatially separating the plasma light and the laser reflected light by a dichroic mirror or the like and using different measurement optical systems. In such a configuration, the number of components of the measurement optical system is large, and it is difficult to downsize the device.

Therefore, an object of the present disclosure is to solve the above-described conventional problems, and to provide a laser machining device that has a small number of components and facilitates downsizing of the device.

In order to achieve the above object, a laser machining device according to an aspect of the present disclosure includes: a welding device that irradiates a workpiece with laser irradiation light to perform welding; and a welding light measurement device including an imaging optical system, a first photodetector, and a second photodetector, the welding light measurement device receiving and measuring welding light emitted from the workpiece during laser welding. The welding light includes first light in a first wavelength region and second light in a second wavelength region, and the imaging optical system includes a wavelength selection mask, and forms an image of a light beam of the first light transmitted through the wavelength selection mask on the first photodetector and forms an image of a light beam of the second light transmitted through the wavelength selection mask on the second photodetector. The wavelength selection mask includes a first region and a second region that receive the welding light, the first region reflects the second light and transmits the first light, the second region transmits the first light and the second light, and the second region has a smaller light receiving area than the first region. The first photodetector and the second photodetector are disposed on an optical axis of the welding light incident on the wavelength selection mask.

According to the laser machining device according to the aspect of the present disclosure, it is possible to provide the laser machining device that has a small number of components and facilitates downsizing of the device.

### BRIEF DESCRIPTION OF THE DRAWINGS

FIG. 1 is a schematic diagram illustrating a configuration of a laser machining device according to Example 1 of an exemplary embodiment of the present disclosure.

FIG. 2 is a diagram illustrating a configuration of a light detector of a welding light measurement device of the laser machining device in FIG. 1.

FIG. 3 is a diagram illustrating a relationship between a sensitivity and a wavelength of the light detector in FIG. 2.

FIG. 4 is a schematic view illustrating a welding light measurement configuration using a conventional imaging optical system for detecting a laser welding state and the light detector in FIG. 2.

FIG. 5A is an enlarged view of portion A in FIG. 4, and is a schematic view illustrating measurement of plasma light.

FIG. 5B is an enlarged view of portion A in FIG. 4, and is a schematic view illustrating measurement of laser reflected light.

FIG. 6 is a schematic diagram illustrating an example of a configuration of a wavelength selection imaging optical system of the laser machining device in FIG. 1.

FIG. 7A is a schematic view illustrating an example of a configuration of a wavelength selection mask of a wavelength selection imaging optical system in FIG. 6.

FIG. 7B is a schematic diagram illustrating another example of the configuration of the wavelength selection mask of the wavelength selection imaging optical system in FIG. 6.

FIG. 8A is a schematic view illustrating measurement of plasma light using the wavelength selection imaging optical system in FIG. 6.

FIG. 8B is an enlarged view of portion B in FIG. 8A.

FIG. 9A is a schematic view illustrating measurement of laser reflected light using the wavelength selection imaging optical system in FIG. 6.

FIG. 9B is an enlarged view of portion C in FIG. 9A.

FIG. 10 is a schematic view illustrating a configuration of a laser machining device according to Example 2 of the exemplary embodiment of the present disclosure.

FIG. 11 is a block diagram illustrating a configuration example of a welding quality evaluation device of the laser machining device in FIG. 10.

### DESCRIPTION OF EMBODIMENT

According to a first aspect of the present disclosure, there is provided a laser machining device including: a welding device that irradiates a workpiece with laser irradiation light to perform welding; and a welding light measurement device including a wavelength selection imaging optical system, a first photodetector, and a second photodetector and receives and measures welding light emitted from the workpiece during laser welding. The welding light includes first light in a first wavelength region and second light in a second wavelength region. The wavelength selection imaging optical system includes a wavelength selection mask and causes the first photodetector and the second photodetector to separately form an image of a light beam of the first light and a light beam of the second light transmitted through the wavelength selection mask with respect to the received welding light. The wavelength selection mask includes a first region and a second region that receive the welding light. The first region reflects the second light and transmits the first light. The second region transmits the first light and the second light. The second region has a smaller light receiving area than the first region. The first photodetector and the second photodetector are arranged to coaxially receive the first light and the second light.

According to this aspect, it is possible to provide the laser machining device that has a small number of components and facilitates downsizing of the device.

A second aspect of the present disclosure provides the laser machining device according to the first aspect, in which the first light is plasma light emitted from the workpiece during laser welding, in which the second light is reflected light of the laser irradiation light by the workpiece during laser welding, in which the first wavelength region is in a visible light region, and in which the second wavelength region is in an infrared light region.

A third aspect of the present disclosure provides the laser machining device according to the first or second aspect, in which the first photodetector has sensitivity to light in the first wavelength region and light in the second wavelength region, and in which the second photodetector has sensitivity to the light in the second wavelength region.

A fourth aspect of the present disclosure provides the laser machining device according to any one of the first to third aspects, in which the first region is subjected to infrared light reflection coating, and in which the infrared light reflection coating has a reflectance of 99% or more with respect to light in the second wavelength region and a transmittance of 95% or more with respect to light in the first wavelength region.

A fifth aspect of the present disclosure provides the laser machining device according to the fourth aspect, in which the infrared light reflection coating reflects light in the infrared light region having a wavelength longer than the second wavelength region and transmits light having a wavelength shorter than the second wavelength region.

A sixth aspect of the present disclosure provides the laser machining device according to the fourth aspect, in which the infrared light reflection coating transmits light other than the second wavelength region.

A seventh aspect of the present disclosure provides the laser machining device according to any one of the first to sixth aspects, in which each of the first region and the second region is rotationally symmetric with respect to an optical axis of the welding light incident on the wavelength selection mask.

An eighth aspect of the present disclosure provides the laser machining device according to any one of the first to seventh aspects, in which the first photodetector and the second photodetector are arranged in order along a propagation direction of the welding light received by the wavelength selection imaging optical system, and in which a part of the second light transmitted through the wavelength selection mask is transmitted through the first photodetector and received by the second photodetector.

A ninth aspect of the present disclosure provides the laser machining device according to any one of the first to eighth aspects, further including a welding quality evaluation device that receives a signal of a light intensity detected by each of the first photodetector and the second photodetector, and evaluates quality of laser welding based on the signal of the light intensity.

Note that by appropriately combining discretionary exemplary embodiments among the various exemplary embodiments described above, the effects of the respective exemplary embodiments can be achieved.

Hereinafter, exemplary embodiments will be described in detail with appropriate reference to the drawings. Descriptions more in detail than necessary may not be described. For example, detailed descriptions of already well-known matters and duplicated description of substantially identical configurations may not be described. This is to avoid an unnecessarily redundant description below and to facilitate understanding of a person skilled in the art.

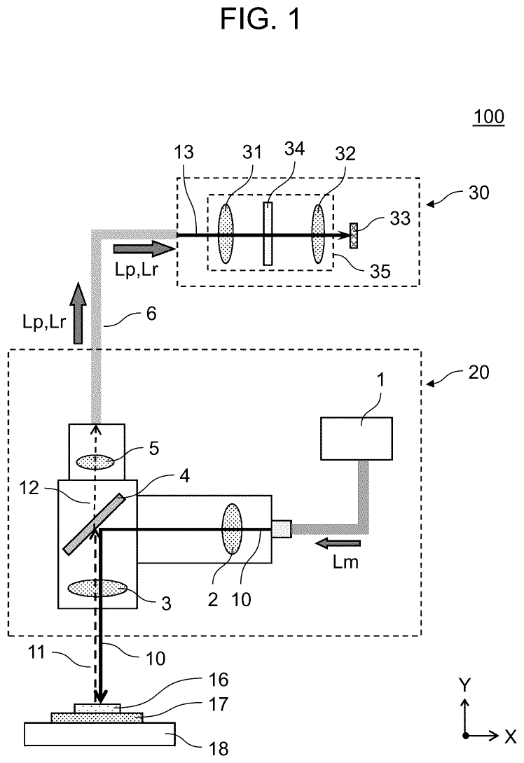

A laser machining device according to a first exemplary embodiment of the present disclosure will be described with reference to FIGS. 1 to 11. The accompanying drawings and the following description are provided for those skilled in the art to fully understand the present disclosure, and are not intended to limit the subject matter described in the claims in any way. Furthermore, in each of the drawings, elements are illustrated exaggeratedly in order to facilitate the description. Note that, in the drawings, substantially the same members are denoted by the same reference numerals.

### (Exemplary Embodiment)

### (Configuration of Laser Machining Device According to Example 1)

An overall configuration of a laser machining device according to Example 1 of an exemplary embodiment of the present disclosure will be described with reference to FIG. 1. FIG. 1 is a schematic diagram illustrating a configuration of laser machining device 100 according to Example 1 of the exemplary embodiment of the present disclosure. In FIG. 1, laser machining device 100 is illustrated on an X-Y plane.

Laser machining device 100 illustrated in FIG. 1 includes welding device 20 and welding light measurement device 30. In laser machining device 100, welding device 20 irradiates workpiece 16 with a laser beam to perform laser welding, and introduces the welding light emitted from the welded portion of workpiece 16 during laser welding into welding light measurement device 30 and measures the welding light, whereby the quality of the laser welding can be evaluated. Hereinafter, components and operation of laser machining device 100 will be described in detail.

### <Welding Device>

Welding device 20 includes laser oscillator 1, collimator lens 2, condenser lens 3, total reflection mirror 4, condenser lens 5, and optical fiber 6.

Laser beam 10 of laser irradiation light Lm emitted from laser oscillator 1 becomes a parallel light beam through collimator lens 2, is reflected by total reflection mirror 4, is condensed by condenser lens 3, and irradiates workpiece 16 along the-Y direction in the drawing. Joint 17 is installed under workpiece 16. Workpiece 16 and joint 17 are fixed on stage 18, moved by stage 18, and irradiated with laser beam 10 to be laser-welded.

At the time of laser welding, welding light 11 emitted from the welded portion of workpiece 16 is transmitted through condenser lens 3 and total reflection mirror 4 along the +Y direction in the drawing, and transmitted welding light 12 is condensed on optical fiber 6 by condenser lens 5 and transmitted to welding light measurement device 30 by optical fiber 6.

For clarity, each light beam is illustrated in FIG. 1 only in the principal ray. Although laser beam 10 of laser irradiation light Lm and welding light 11 are separately illustrated between total reflection mirror 4 and workpiece 16, actually, laser beam 10 of laser irradiation light Lm and welding light 11 pass through condenser lens 3 along the same path.

### <Welding Light Measurement Device>

Welding light 13 transmitted to optical fiber 6 and incident on welding light measurement device 30 along the +X direction in the drawing includes plasma light Lp generated in the welded portion of workpiece 16 and reflected light Lr (hereinafter, referred to as laser reflected light Lr) with respect to the laser irradiation light by workpiece 16. Welding light measurement device 30 includes wavelength selection imaging optical system 35 and light detector 33. In the present exemplary embodiment, wavelength selection imaging optical system 35 separately images incident plasma light Lp and laser reflected light Lr on light detector 33, and light detector 33 measures the respective light intensities of plasma light Lp and laser reflected light Lr.

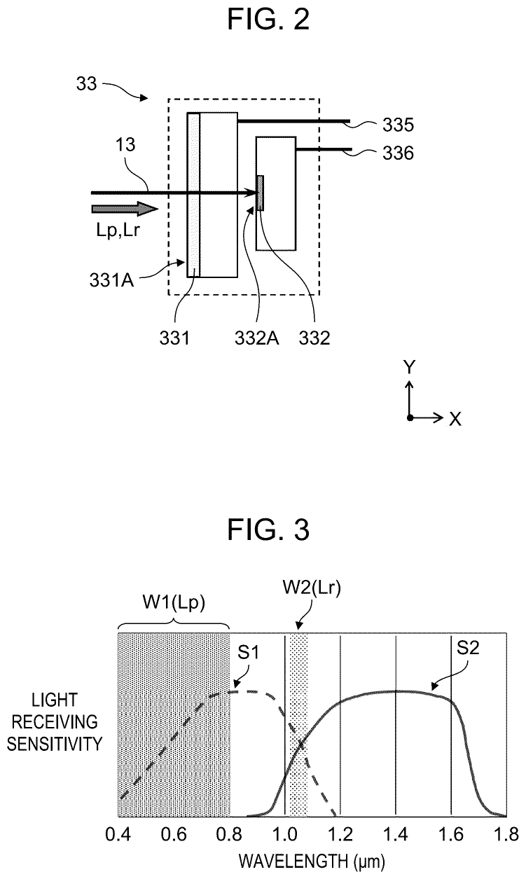

First, light detector 33 of welding light measurement device 30 will be described with reference to FIGS. 2 and 3. FIG. 2 is a diagram illustrating a configuration of light detector 33 of welding light measurement device 30 of laser machining device 100 in FIG. 1. FIG. 3 is a diagram illustrating a relationship between the sensitivity and the wavelength of light detector 33 in FIG. 2.

Light detector 33 can be constituted by a photodiode, and can monitor the respective light intensities of received plasma light Lp and laser reflected light Lr. Light detector 33 is selected according to a wavelength region of incident light. For example, since plasma light Lp is light in a visible light region having a wavelength region of 400 to 800 nm among welding light 13 incident on welding light measurement device 30, a photodiode having sensitivity in a wavelength region of 400 to 800 nm can be selected in order to measure plasma light Lp.

On the other hand, laser oscillator 1 for laser welding may be a fiber laser having an oscillation wavelength of 1070 nm, a YAG laser having an oscillation wavelength of 1064 nm, a disk laser having an oscillation wavelength around 1030 nm, or the like. Therefore, laser irradiation light Lm is light in the infrared light region around 1000 nm. In order to measure laser reflected light Lr in a similar wavelength region, a photodiode having sensitivity in a wavelength region around 1000 nm can be selected.

A conventional welding state detection device is configured to measure plasma light in a visible light region and laser reflected light in an infrared light region by using two independent light detectors as in Patent Literature 1, for example. In recent years, a light detector in which two photodetectors having mutually different sensitivity regions are stacked and integrated has been developed, and such an integrated light detector can measure light in a wide wavelength region from a visible light region to an infrared light region. Light detector 33 of laser machining device 100 according to the present disclosure is configured to coaxially receive plasma light Lp in the visible light region and laser reflected light Lr in the infrared light region and measure the respective light intensities.

As illustrated in FIG. 2, light detector 33 according to the present exemplary embodiment includes first photodetector 331 and second photodetector 332, and first photodetector 331 and second photodetector 332 are coaxially disposed in the linear direction with respect to incident welding light 13. As illustrated in the drawing, first photodetector 331 and second photodetector 332 are sequentially disposed along the propagation direction of received welding light 13, and welding light 13 is coaxially received by light receiving surfaces 331A and 332A. Light receiving surface 332A of second photodetector 332 can be configured to be smaller than light receiving surface 331A of first photodetector 331. Each of first photodetector 331 and second photodetector 332 includes output terminal portion 335,336, and can output an electric signal corresponding to the amount of received light by photoelectric conversion.

FIG. 3 illustrates a relationship between the light receiving sensitivity characteristic and the wavelength of light detector 33. First photodetector 331 has a central wavelength of 800 nm and sensitivity region S1 of about 400 to 1200 nm. On the other hand, second photodetector 332 has a center wavelength of 1400 nm and sensitivity region S2 of about 900 to 1800 nm. Light detector 33 configured as described above has sensitivity over a wide wavelength region of 400 to 1800 nm, and can detect light from a visible light region to an infrared light region. In the wavelength region around 1000 nm, sensitivity region S1 of first photodetector 331 and sensitivity region S2 of second photodetector 332 overlap each other. Therefore, light in the wavelength region around 1000 to 1100 nm is detected by both the photodetectors. Here, first photodetector 331 arranged on the front side in the-X direction of light detector 33 illustrated in FIG. 2 has a characteristic of at least partially transmitting light in an infrared light region having a wavelength of 1000 nm or more. The light in the infrared light region transmitted through first photodetector 331 is received by second photodetector 332 disposed on the rear side (+Z side illustrated in FIG. 2) of light detector 33.

As illustrated in FIG. 3, since wavelength region W1 of plasma light Lp in the visible light region is within sensitivity region S1 of first photodetector 331, plasma light Lp is detected only by first photodetector 331. On the other hand, wavelength region W2 of laser reflected light Lr in the infrared light region is in an overlapping region between sensitivity region S1 of first photodetector 331 and sensitivity region S2 of second photodetector 332. Therefore, a part of laser reflected light Lr is absorbed and detected by first photodetector 331 (hereinafter, referred to as first reflected light portion Lr1). The portion of the laser reflected light transmitted through first photodetector 331 (hereinafter, referred to as second reflected light portion Lr2) is detected by second photodetector 332.

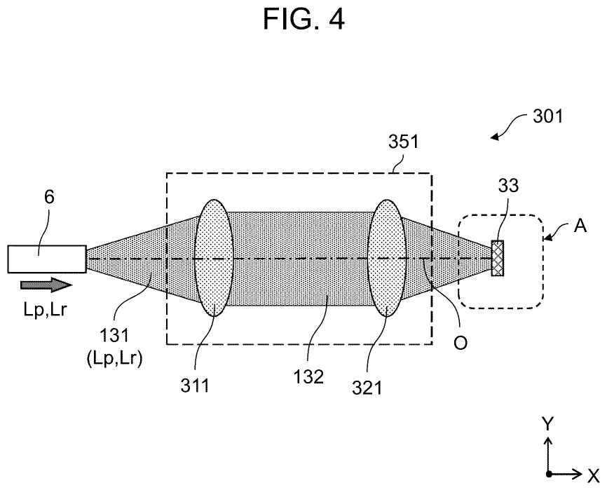

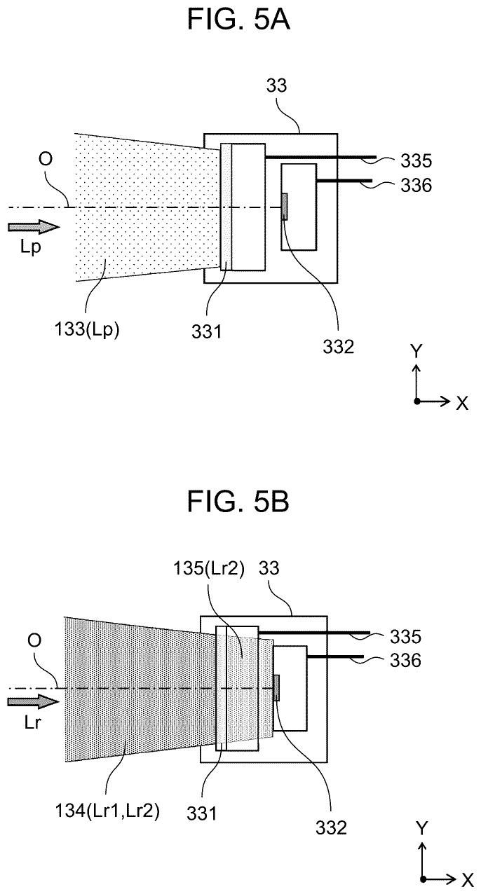

However, in a case where the laser welding state is detected by using light detector 33 configured to coaxially receive plasma light Lp in the visible light region and reflected light Lr in the infrared light region and detect plasma light Lp and reflected light Lr, respectively, and the conventional imaging optical system, the accuracy of the quality evaluation of welding may be deteriorated. Hereinafter, with reference to FIGS. 4 to 5B, a description will be given of degradation in accuracy of quality evaluation of welding that occurs when light detector 33 and the conventional imaging optical system are used.

### <Occurrence of Decrease in Accuracy of Quality Evaluation of Welding>

FIG. 4 is a schematic diagram illustrating welding light measurement configuration 301 using conventional imaging optical system 351 for detecting a laser welding state and light detector 33 in FIG. 2. FIG. 5A is an enlarged view of portion A in FIG. 4, and is a schematic view illustrating measurement of plasma light Lp. FIG. 5B is an enlarged view of portion A in FIG. 4, and is a schematic view illustrating measurement of laser reflected light Lr.

Welding light measurement configuration 301 illustrated in FIG. 4 includes imaging optical system 351 including collimator lens 311 and imaging lens 321, which is often used in the related art, and light detector 33. Welding light 131 transmitted by optical fiber 6 includes plasma light Lp and laser reflected light Lr, is propagated in the +X direction in the drawing, becomes parallel light beam 132 along incident optical axis O by collimator lens 311, and is further imaged on the light receiving surface of light detector 33 by imaging lens 321.

As illustrated in FIG. 5A, light beam 133 of plasma light Lp having reached light detector 33 is imaged and detected by first photodetector 331 of light detector 33. An electric signal proportional to the light intensity of plasma light Lp can be output by output terminal portion 335. On the other hand, as illustrated in FIG. 5B, light beam 134 of laser reflected light Lr that has reached light detector 33 is incident on first photodetector 331 disposed on the front side of light detector 33 in the-X direction. After first reflected light portion Lr1 of laser reflected light Lr is absorbed and detected by first photodetector 331, light beam 135 of second reflected light portion Lr2 transmitted through first photodetector 331 is imaged and detected on second photodetector 332 disposed on the rear side (+Z side in the drawing). An electric signal proportional to the light intensity of second reflected light portion Lr2 can be output by output terminal portion 336. In addition, an electric signal proportional to the light intensity of first reflected light portion Lr1 absorbed and detected by first photodetector 331 is output by output terminal portion 335 of first photodetector 331. As described above, as illustrated in FIGS. 5A and 5B, first photodetector 331 and second photodetector 332 are disposed on optical axis O of the welding light incident on wavelength selection mask 34.

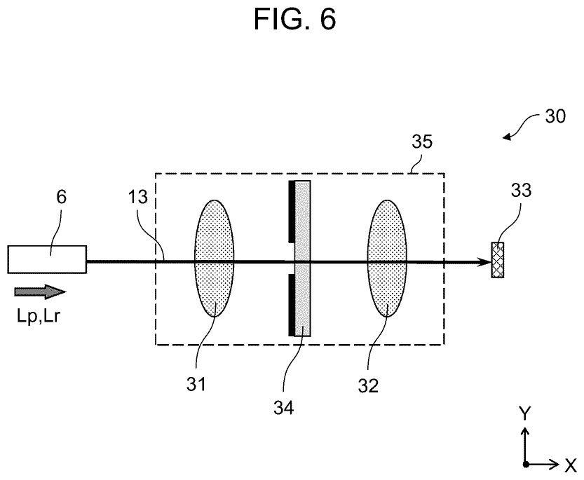

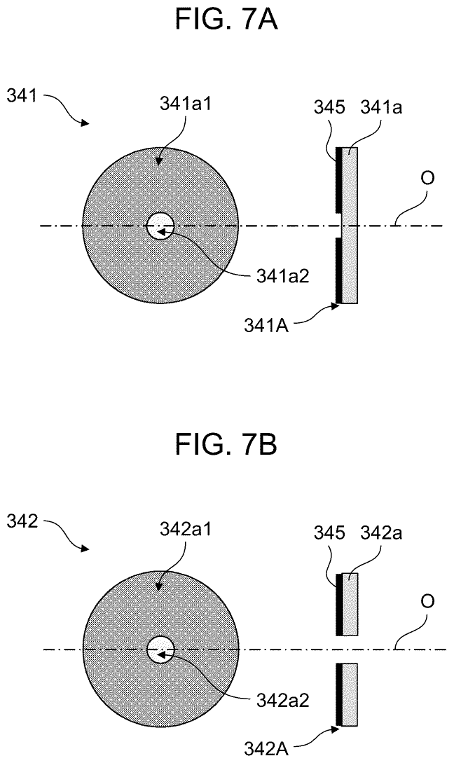

As described above, the light detected by first photodetector 331 includes both plasma light Lp and first reflected light portion Lr1 of laser reflected light Lr, and the light detected by second photodetector 332 includes second reflected light portion Lr2 of laser reflected light Lr. That is, plasma light Lp and laser reflected light Lr cannot be measured independently. Therefore, the accuracy of the quality evaluation of welding performed based on the light intensity detected by each of first photodetector 331 and second photodetector 332 decreases. Therefore, in the present exemplary embodiment, by applying wavelength selection imaging optical system 35 to laser machining device 100, it is possible to improve the occurrence of deterioration in accuracy of quality evaluation of welding. Hereinafter, a configuration of the wavelength selection imaging optical system according to the present disclosure will be described with reference to FIGS. 6 to 7B.

### <Configuration of Wavelength Selection Imaging Optical System>

FIG. 6 is a schematic diagram illustrating an example of a configuration of wavelength selection imaging optical system 35 of laser machining device 100 in FIG. 1. FIG. 7A is a schematic diagram illustrating a configuration example of wavelength selection mask 341 of wavelength selection imaging optical system 35 in FIG. 6. FIG. 7B is a schematic diagram illustrating a configuration example of wavelength selection mask 342 of the wavelength selection imaging optical system in FIG. 6.

wavelength selection imaging optical system 35 illustrated in FIG. 6 includes collimator lens 31, wavelength selection mask 34, wavelength selection imaging optical system 35 including imaging lens 32, and light detector 33, which are coaxially disposed in order along the propagation direction (+X direction in the drawing) of received welding light 13. Welding light 13 transmitted by optical fiber 6 includes plasma light Lp and laser reflected light Lr, and reaches wavelength selection mask 34 through collimator lens 31, and plasma light Lp and laser reflected light Lr transmitted through wavelength selection mask 34 are imaged and detected by the imaging lens 32 on light detector 33.

### (First Configuration Example of Wavelength Selection Mask)

Wavelength selection mask 341 as a configuration example illustrated in FIG. 7A is not limited thereto, but can be configured by disk-shaped glass substrate 341a. In the present exemplary embodiment, as illustrated in the drawing, first region 341a1 and second region 341a2 for receiving welding light 13 are formed on light receiving surface 341A of substrate 341a. Infrared light reflection coating 345 is applied to first region 341a1, and infrared light reflection coating 345 is a metal vapor deposition film in the present exemplary embodiment, and has a characteristic of reflecting light in a wavelength region around wavelength 1070 nm of laser reflected light Lr and transmitting light in other wavelength regions. On the other hand, second region 341a2 is not subjected to infrared light reflection coating, and has a characteristic of transmitting light in a wide wavelength region including plasma light Lp and laser reflected light Lr. As a result, among welding light 13 incident on light receiving surface 341A of wavelength selection mask 341, plasma light Lp in the visible light region is transmitted through both first region 341a1 and second region 341a2 and reaches light detector 33 to be detected, whereas laser reflected light Lr in the infrared light region is reflected by first region 341a1, and a portion transmitted through second region 341a2 reaches light detector 33 to be detected. As illustrated in the drawing, second region 341a2 has a smaller light receiving area than first region 341a1. As a result, wavelength selection mask 341 can transmit substantially all the light amount with respect to received plasma light Lp, and can transmit only a part of the light amount with respect to laser reflected light Lr.

In the present exemplary embodiment, infrared light reflection coating 345 is configured to have a reflectance of 99% or more with respect to light in a wavelength region of reflected light Lr near a wavelength of 1070 nm and a transmittance of 95% or more with respect to light in a wavelength region of plasma light Lp having a wavelength region of 400 to 800 nm. However, the characteristic of infrared light reflection coating 345 is not limited thereto. For example, infrared light reflection coating 345 may be configured to have a characteristic of reflecting light in the infrared light region on the long wavelength side from the wavelength region of laser reflected light Lr, for example, light of 1000 to 1800 nm, and transmitting light on the short wavelength side from the wavelength region of laser reflected light Lr, for example, light of 400 to 900 nm. In the present exemplary embodiment, first region 341a1 and second region 341a2 are configured to be rotationally symmetric with respect to optical axis O of the welding light incident on wavelength selection mask 341. Second region 341a2 is formed in a central portion of substrate 341a, and first region 341a1 is formed in an annular shape surrounding second region 341a2. However, the present disclosure is not limited to the shapes of the first region and the second region of the wavelength selection mask. The first region and the second region of the wavelength selection mask may have other shapes depending on the application.

### (Second Configuration Example of Wavelength Selection Mask)

Wavelength selection mask 342 illustrated in FIG. 7B is different from wavelength selection mask 341 illustrated in FIG. 7A in a configuration including annular substrate 342a. In wavelength selection mask 342, infrared light reflection coating 345 similar to that of wavelength selection mask 341 is applied to light receiving surface 342A of substrate 342a to form first region 342a1. In the present exemplary embodiment, central portion penetrating substrate 342a constitutes second region 342a2, and second region 342a2 transmits both plasma light Lp and laser reflected light Lr. With wavelength selection mask 342 configured as described above, in welding light 13 received by light receiving surface 342A, plasma light Lp in the visible light region is transmitted through both first region 342a1 and second region 342a2, reaches light detector 33, and is detected. On the other hand, the portion of laser reflected light Lr in the infrared light region that has passed through second region 342a2 reaches light detector 33 and is detected.

### <Operation of Wavelength Selection Imaging Optical System>

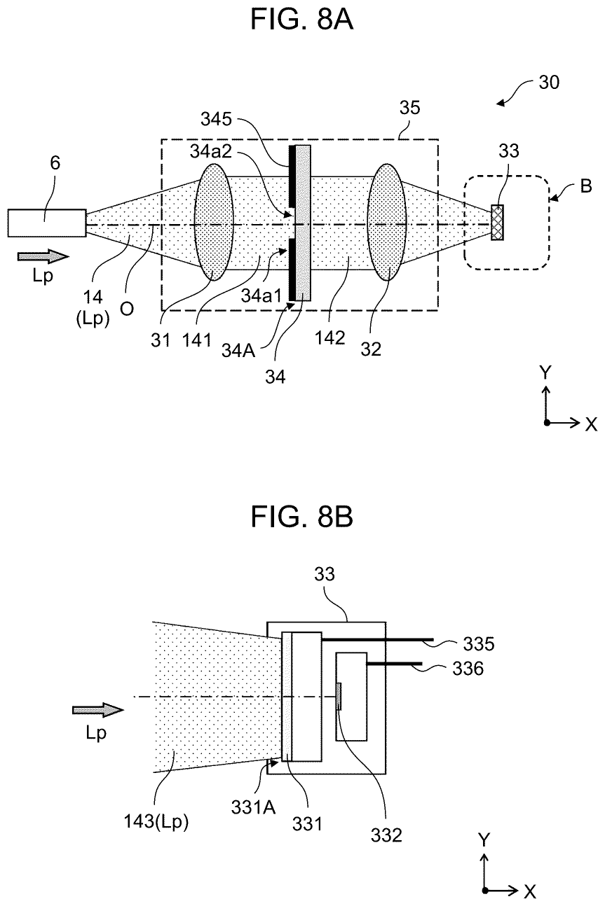

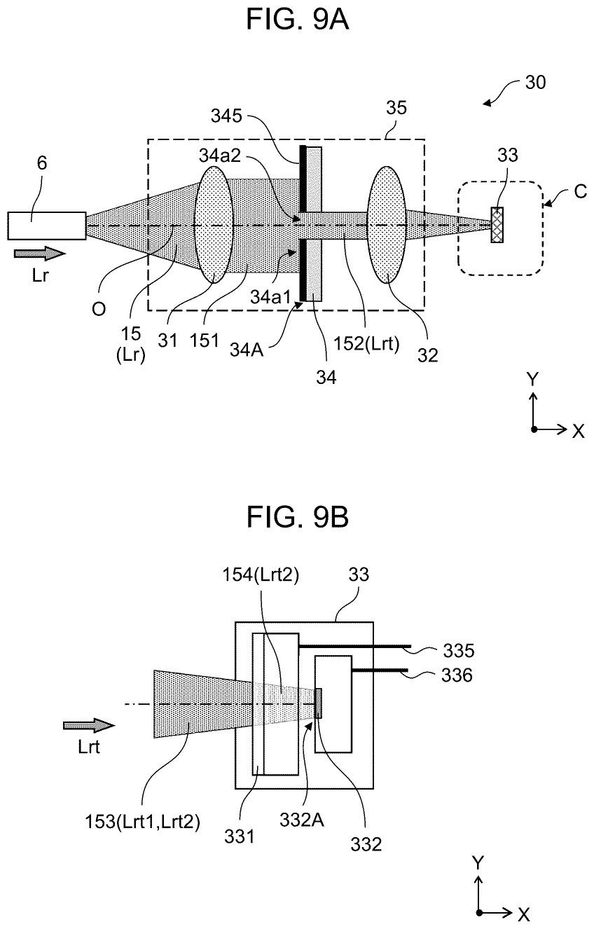

The measurement of plasma light Lp and laser reflected light Lr using wavelength selection imaging optical system 35 according to the present disclosure will be described with reference to FIGS. 8A to 9B. In the following description, welding light 13 transmitted from optical fiber 6 will be described separately as light beam 14 of plasma light Lp and light beam 15 of laser reflected light Lr. FIG. 8A is a schematic view illustrating measurement of plasma light Lp using wavelength selection imaging optical system 35 in FIG. 6. FIG. 8B is an enlarged view of portion B in FIG. 8A. FIG. 9A is a schematic view illustrating measurement of laser reflected light Lr using wavelength selection imaging optical system 35 in FIG. 6. FIG. 9B is an enlarged view of portion C in FIG. 9A.

As illustrated in FIG. 8A, light beam 14 of plasma light Lp having the wavelength region of 400 to 800 nm transmitted from optical fiber 6 reaches wavelength selection mask 34 with parallel light beam 141 by collimator lens 31. In the present exemplary embodiment, infrared light reflection coating 345 applied to first region 34a1 in the outer peripheral portion of light receiving surface 34A of wavelength selection mask 34 has a characteristic of transmitting light in the visible light region, and second region 34a2 in the central portion of wavelength selection mask 34 transmits light in the visible light region and the infrared light region. Therefore, plasma light Lp is transmitted through wavelength selection mask 34, and light beam 142 of transmitted plasma light Lp is focused by imaging lens 32, and light beam 143 is imaged on first photodetector 331 of light detector 33 (FIG. 8B).

As described above, among transmitted welding light 13, plasma light Lp passes through wavelength selection mask 34, and is received and detected by first photodetector 331 of light detector 33, and a signal proportional to the light intensity of plasma light Lp can be output from output terminal portion 335 of first photodetector 331.

Here, as illustrated in FIG. 8B, light beam 143 of plasma light Lp formed on first photodetector 331 can form a beam spot on light receiving surface 331A of first photodetector 331, which is equal to or smaller than light receiving surface 331A. As a result, the energy (light intensity) of plasma light Lp incident on wavelength selection imaging optical system 35 can be used to the maximum.

Next, as illustrated in FIG. 9A, light beam 15 of laser reflected light Lr having a wavelength of about 1070 nm transmitted from optical fiber 6 reaches wavelength selection mask 34 with parallel light beam 151 by collimator lens 31. In the present exemplary embodiment, infrared light reflection coating 345 applied to first region 34a1 in the outer peripheral portion of light receiving surface 34A of wavelength selection mask 34 has a characteristic of reflecting light having a wavelength of around 1070 nm. Therefore, light beam 151 of laser reflected light Lr is reflected by infrared light reflection coating 345 in first region 34a1 of wavelength selection mask 34. On the other hand, since infrared light reflection coating 345 is not applied to second region 34a2 in the central portion of wavelength selection mask 34 and light in the infrared light region is transmitted, light beam 151 of laser reflected light Lr is transmitted through wavelength selection mask 34 in second region 34a2.

As illustrated in FIG. 9B, light beam 152 of laser reflected light Lrt transmitted through wavelength selection mask 34 is focused by imaging lens 32, and light beam 153 reaches first photodetector 331 arranged on the front side of light detector 33 in the −X direction. First reflected light portion Lrt1 of laser reflected light Lrt transmitted through wavelength selection mask 34 is absorbed and detected by first photodetector 331. Light beam 154 of second reflected light portion Lrt2 transmitted through first photodetector 331 is imaged and detected by second photodetector 332 arranged on the rear side (+Z side in the drawing) of light detector 33.

As described above, in transmitted welding light 13, second reflected light portion Lrt2 of laser reflected light Lr that has passed through second region 34a2 of wavelength selection mask 34 and further reached second photodetector 332 is received and detected by second photodetector 332 of light detector 33, and a signal proportional to the light intensity of second reflected light portion Lrt2 can be output from output terminal portion 336 of second photodetector 332.

Here, in transmitted welding light 13, first reflected light portion Lrt1 of laser reflected light Lr that has passed through second region 34a2 of wavelength selection mask 34 is detected by first photodetector 331 of light detector 33 together with plasma light Lp. However, as illustrated in the drawing, since second region 34a2 of wavelength selection mask 34 is configured to have a smaller light receiving area than first region 34a1, first reflected light portion Lrt1 detected by first photodetector 331 is a part of received laser reflected light Lr. Therefore, the ratio of the laser reflected light included in the light detected by first photodetector 331 is reduced as compared with the case of using the conventional imaging optical system illustrated in FIGS. 4 to 5B. As a result, the plasma light and the laser reflected light can be measured by first photodetector 331 and second photodetector 332 substantially independently of each other. Therefore, the accuracy of the quality evaluation of welding performed based on the light intensity detected by each of first photodetector 331 and second photodetector 332 can be improved.

Note that, as illustrated in FIG. 9B, light beam 154 of second reflected light portion Lrt2 imaged on second photodetector 332 can form a beam spot on light receiving surface 332A of second photodetector 332, equal to or smaller than light receiving surface 332A. As a result, the energy (light intensity) of second reflected light portion Lrt2 reaching second photodetector 332 can be used to the maximum.

### (Specific Example)

The improvement of the accuracy of the quality evaluation of welding by wavelength selection mask 34 of the present exemplary embodiment will be described with a specific numerical example.

For example, the size of the beam spot on the light receiving surface of first photodetector 331 of light detector 33 is set to Φ3 mm, and the size of the beam spot on the light receiving surface of second photodetector 332 is set to 0.5 mm. The ratio between the light intensity of plasma light Lp and the light intensity of laser reflected light Lr in welding light 13 is 1:1.

At this time, in welding light measurement configuration 301 using the conventional imaging optical system illustrated in FIG. 4, both plasma light Lp and laser reflected light Lr are incident on the light receiving surface of first photodetector 331 at a beam spot of Φ3 mm, and the ratio of the light intensity of plasma light Lp and the light intensity of laser reflected light Lr is also 1:1, similarly to welding light 13.

On the other hand, in a case where wavelength selection imaging optical system 35 according to the present disclosure illustrated in FIG. 6 is applied, plasma light Lp is incident on the light receiving surface of first photodetector 331 at a beam spot of Φ3 mm, whereas first reflected light portion Lrt1 of laser reflected light Lr detected by first photodetector 331 is incident at a beam spot of approximately 0.5 mm. That is, with respect to a beam spot of Φ3 mm of light beam 151 of laser reflected light Lr received by wavelength selection mask 34, only first reflected light portion Lrt1 that has passed through a portion of about Φ0.5 mm in the central portion can reach first photodetector 331. Assuming a light beam having a uniform light intensity distribution, first reflected light portion Lrt1 received by first photodetector 331 is only about 2.8% of laser reflected light Lr received by wavelength selection imaging optical system 35. Therefore, the ratio between the light intensity of plasma light Lp received and detected by first photodetector 331 and the light intensity of first reflected light portion Lrt1 of laser reflected light Lr is 1:0.028.

As described above, in a case where wavelength selection imaging optical system 35 according to the present disclosure is applied, as compared with a case where the conventional imaging optical system is used, the relative intensity of the laser reflected light with respect to the plasma light detected by first photodetector 331 is as very small as only 2.8%, and it can be said that the signal output by first photodetector 331 is substantially the light intensity of plasma light Lp included in the welding light. The signal output from second photodetector 332 is the light intensity of first reflected light portion Lrt1 of a part of laser reflected light Lr included in the welding light. As a result, since the plasma light and the laser reflected light can be measured substantially independently, the accuracy of the quality evaluation of welding can be improved.

Note that first reflected light portion Lrt1 of laser reflected light Lr detected by first photodetector 331 can be reduced as the light receiving area of second region 34a2 of wavelength selection mask 34 is smaller. On the other hand, the light intensity of second reflected light portion Lrt2 of laser reflected light Lr detected by second photodetector 332 decreases. Second region 34a2 of wavelength selection mask 34 can be configured according to the light intensity of the welding light to be received, the ratio between plasma light Lp and laser reflected light Lr, the size of the beam spot, and the sensitivity of the light detector.

As described above, laser machining device 100 of the present disclosure can perform wavelength separation on welding light emitted from the welded portion during laser welding, and coaxially measure the obtained plasma light and laser reflected light in different wavelength regions to evaluate welding quality.

### (Configuration of Laser Machining Device According to Second Exemplary Embodiment)

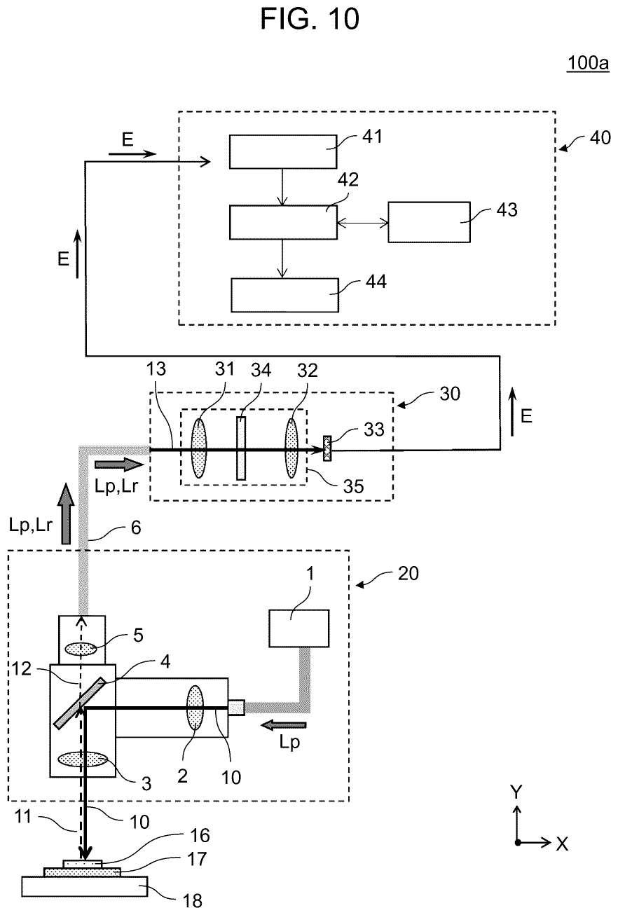

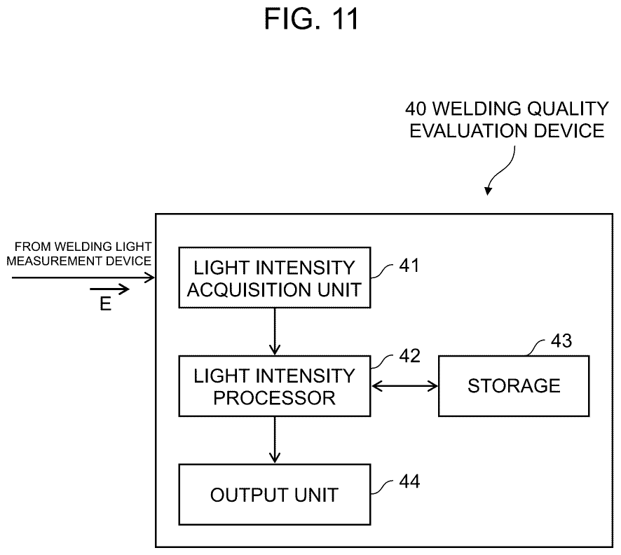

An overall configuration of a laser machining device according to Example 2 of the exemplary embodiment of the present disclosure will be described with reference to FIGS. 10 to 11. FIG. 10 is a schematic diagram illustrating a configuration of laser machining device 100a according to Example 2 of the exemplary embodiment of the present disclosure. FIG. 11 is a block diagram illustrating a configuration example of welding quality evaluation device 40 of laser machining device 100a in FIG. 10. Laser machining device 100a illustrated in FIG. 10 is different from laser machining device 100 illustrated in FIG. 1 in including welding quality evaluation device 40. In FIG. 10, elements similar to those of laser machining device 100 in FIG. 1 are denoted by the same reference numerals, and a detailed description thereof will be omitted.

As illustrated in FIG. 10, laser machining device 100a includes welding device 20, welding light measurement device 30, and welding quality evaluation device 40. Welding device 20 irradiates workpiece 16 with the laser beam to perform the laser welding, and introduces the welding light emitted from the welded portion of workpiece 16 during the laser welding into welding light measurement device 30 to measure the welding light. The light intensity measured by welding light measurement device 30 is transmitted to welding quality evaluation device 40, and welding quality evaluation device 40 can evaluate the quality of the laser welding based on the received light intensity. Note that arrow E in FIG. 10 indicates the transmission direction of the light intensity data measured by welding light measurement device 30. In addition, welding device 20 and welding light measurement device 30 of laser machining device 100a have the same configurations as those of laser machining device 100 illustrated in FIG. 1. Hereinafter, the configuration of welding quality evaluation device 40 will be described in detail.

Welding quality evaluation device 40 may be, for example, a computer. As the computer device, a general-purpose computer device can be used. For example, as illustrated in FIG. 11, the computer device includes light intensity acquisition unit 41, light intensity processor 42, storage 43, and output unit 44, and is electrically connected to welding light measurement device 30. Welding quality evaluation device 40 can evaluate the quality of welding based on the measurement data of the light intensity from welding light measurement device 30.

Specifically, light intensity acquisition unit 41 acquires, from welding light measurement device 30, data of a signal proportional to the light intensity of plasma light Lp and laser reflected light Lr emitted from the welded portion of workpiece 16 during laser welding measured by light detector 33.

Light intensity processor 42 may be, for example, a central processing operator (CPU), a microcomputer, or a processing device capable of executing computer-executable instructions. Light intensity processor 42 executes a data processing program on the basis of the data of the signal of plasma light Lp and the data of the signal of laser reflected light Lr acquired by light intensity acquisition unit 41 and the correlation data stored in storage 43 to evaluate the quality of welding.

storage 43 may be, for example, an auxiliary storage device such as a hard disk drive, and stores a data processing program executed by light intensity processor 42, various data, and the like. Data stored in storage 43 includes, for example, correlation data between the signal of plasma light Lp, the signal of laser reflected light Lr, and the quality of welding.

Output unit 44 may be an output interface circuit that outputs data from welding quality evaluation device 40 to the outside.

Welding quality evaluation device 40 may acquire a data processing program executed by light intensity processor 42 from a portable storage medium. The storage medium is a medium that accumulates information such as a program by an electrical, magnetic, optical, mechanical, or chemical action so that a computer or another device, a machine, or the like can read the information such as the program recorded therein. When welding quality evaluation device 40 is connected to a network, a data processing program or the like may be downloaded from the network as necessary.

As described above, the laser machining device of the present disclosure can coaxially receive and measure the welding light including the plasma light emitted from the workpiece and the laser reflected light during the laser welding using the light detector including the two photodetectors having different sensitivity regions. At this time, by using the wavelength selection imaging optical system including the wavelength selection mask, the plasma light and the laser reflected light are separately imaged on two photodetectors, a light intensity is measured independently of each other, and quality evaluation of welding can be performed based on the obtained light intensity.

As described above, the accompanying drawings and the detailed description have been provided to describe the exemplary embodiment of the technique in the present disclosure. Thus, components described in the accompanying drawings and the detailed description may include not only components essential for solving the problem, but also components non-essential for solving the problem to describe the above techniques. Therefore, such non-essential components should not be immediately construed as essential merely on the basis of the fact that those non-essential components are illustrated in the accompanying drawings or described in the detailed descriptions.

Although the present disclosure has been fully described in connection with a preferred exemplary embodiment with reference to the accompanying drawings, various modifications can be made within the scope of the claims. Such modifications and exemplary embodiments obtained by appropriately combining technical units disclosed in different exemplary embodiments are also included in the technical scope of the present disclosure.

### INDUSTRIAL APPLICABILITY

The laser machining device of the present disclosure is applicable to a device that measures welding light including light in different wavelength regions generated during laser welding. The present disclosure can be used, for example, for quality evaluation of welding based on measurement of welding light generated during laser welding.

### REFERENCE MARKS IN THE DRAWINGS

1: laser oscillator

2, 311: collimator lens

3: condenser lens

4: total reflection mirror

5: condenser lens

6: optical fiber

10: laser beam

11, 12, 13: welding light

14, 15: light beam

16: workpiece

17: joint

18: stage

20: welding device

30: welding light measurement device

31, 32: lens

33: light detector

34, 341, 342: wavelength selection mask

35: wavelength selection imaging optical system

40: welding quality evaluation device

41: light intensity acquisition unit

42: light intensity processor

43: storage

44: output unit

100, 100a: laser machining device

331, 332: photodetector

1. A laser machining device comprising:
a welding device that irradiates a workpiece with laser irradiation light to perform welding; and
a welding light measurement device including an imaging optical system, a first photodetector, and a second photodetector, the welding light measurement device receiving and measuring welding light emitted from the workpiece during laser welding,
wherein the welding light includes first light in a first wavelength region and second light in a second wavelength region,
the imaging optical system includes a wavelength selection mask, and forms an image of a light beam of the first light transmitted through the wavelength selection mask on the first photodetector and forms an image of a light beam of the second light transmitted through the wavelength selection mask on the second photodetector,
the wavelength selection mask includes a first region and a second region that receive the welding light,
the first region reflects the second light and transmits the first light,
the second region transmits the first light and the second light,
the second region has a smaller light receiving area than that of the first region, and
the first photodetector and the second photodetector are disposed on an optical axis of the welding light incident on the wavelength selection mask.

2. The laser machining device according to claim 1, wherein
the first light is plasma light emitted from the workpiece during laser welding,
the second light is reflected light of the laser irradiation light by the workpiece during laser welding,
the first wavelength region is in a visible light region, and
the second wavelength region is in an infrared light region.

3. The laser machining device according to claim 1, wherein
the first photodetector has sensitivity to light in the first wavelength region and light in the second wavelength region, and
the second photodetector has sensitivity to the light in the second wavelength region.

4. The laser machining device according to claim 1, wherein
the wavelength selection mask further includes an infrared light reflection coating applied to the first region, and
the infrared light reflection coating has a reflectance of 99% or more with respect to light in the second wavelength region and a transmittance of 95% or more with respect to light in the first wavelength region.

5. The laser machining device according to claim 4, wherein the infrared light reflection coating reflects infrared light having a wavelength longer than that of the second wavelength region and transmits light having a wavelength shorter than that of the second wavelength region.

6. The laser machining device according to claim 4, wherein the infrared light reflection coating transmits light other than the second wavelength region.

7. The laser machining device according to claim 1, wherein each of the first region and the second region is rotationally symmetric with respect to an optical axis of the welding light incident on the wavelength selection mask.

8. The laser machining device according to claim 1, wherein
the first photodetector and the second photodetector are arranged in order along a propagation direction of the welding light received by the imaging optical system, and
a part of the second light transmitted through the wavelength selection mask is transmitted through the first photodetector and received by the second photodetector.

9. The laser machining device according to claim 1, further comprising a welding quality evaluation device that receives a signal of a light intensity detected by each of the first photodetector and the second photodetector, and evaluates quality of laser welding based on the signal of the light intensity.
